(19) United States
(12) Patent Application Publication
(10) Pub. No.: US 2019/0286883 A1
(43) Pub. Date: Sep. 19, 2019

(54) FACE RECOGNITION SECURITY ASSEMBLY

(71) Applicant: Victor Flood, JR., Birmingham, AL (US)

(72) Inventor: Victor Flood, JR., Birmingham, AL (US)

(21) Appl. No.: 15/925,752

(22) Filed: Mar. 19, 2018

(51) Int. Cl. G06K 9/00; G07C 9/00; G06K 9/20

(52) U.S. Cl. CPC G06K 9/00255; G07C 9/00158; G06K 9/00288; G06K 9/2018; G07C 9/00563

(57) ABSTRACT

A face recognition security assembly for locking a door of a building when a face of an individual approaching the building cannot be seen includes a face recognition camera that may be mounted on an external wall of a building. The face recognition camera is positioned above a door of the building to capture images of a face of an individual approaching the door. A lock is coupled to the door such that the lock selectively locks the door when the lock is turned on. The lock is turned on when the face recognition camera fails to capture an image of the individual's face approaching the door.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to security devices and more particularly pertains to a new security device for locking a door of a building when a face of an individual approaching the building cannot be seen.

### BRIEF SUMMARY OF THE INVENTION

An embodiment of the disclosure meets the needs presented above by generally comprising a face recognition camera that may be mounted on an external wall of a building. The face recognition camera is positioned above a door of the building to capture images of a face of an individual approaching the door. A lock is coupled to the door such that the lock selectively locks the door when the lock is turned on. The lock is turned on when the face recognition camera fails to capture an image of the individual's face approaching the door.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a housing of a face recognition security assembly according to an embodiment of the disclosure.

FIG. 2 is a perspective view of a housing of an embodiment of the disclosure.

FIG. 3 is a left side view of a housing of an embodiment of the disclosure.

FIG. 4 is a bottom view of an embodiment of the disclosure.

FIG. 5 is a perspective in-use view of an embodiment of the disclosure.

FIG. 6 is a schematic view of an embodiment of the disclosure.

### DETAILED DESCRIPTION OF THE INVENTION

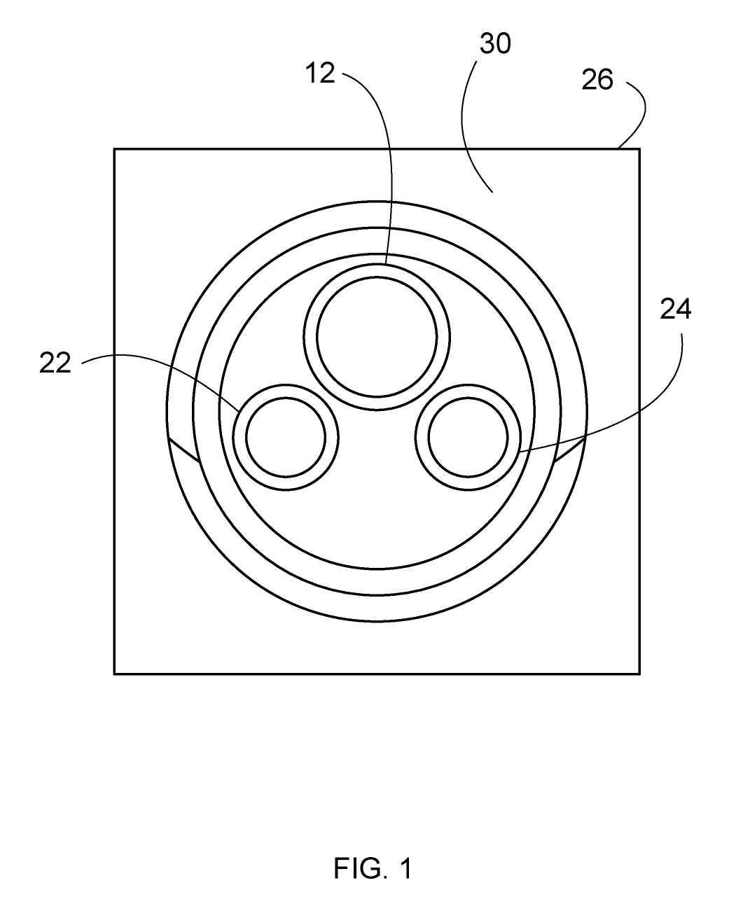

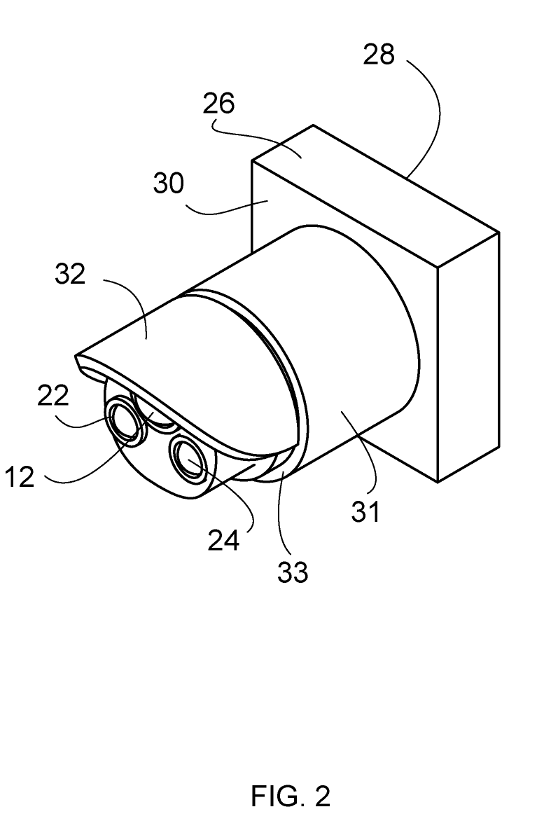

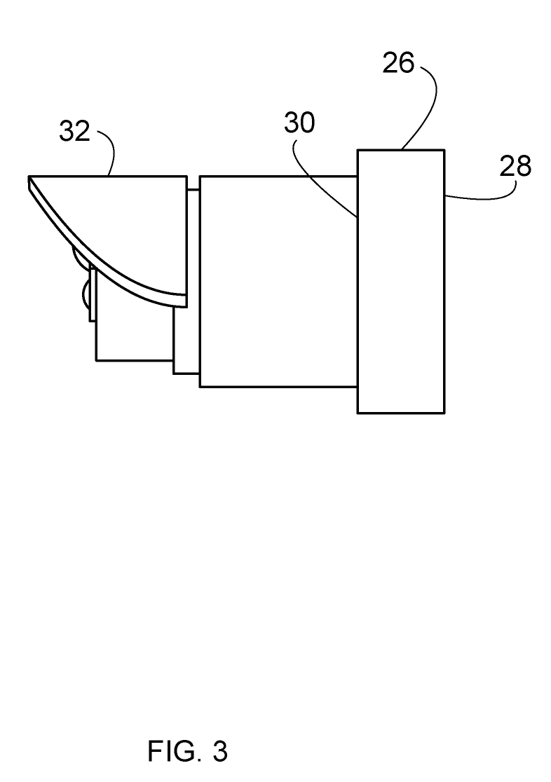

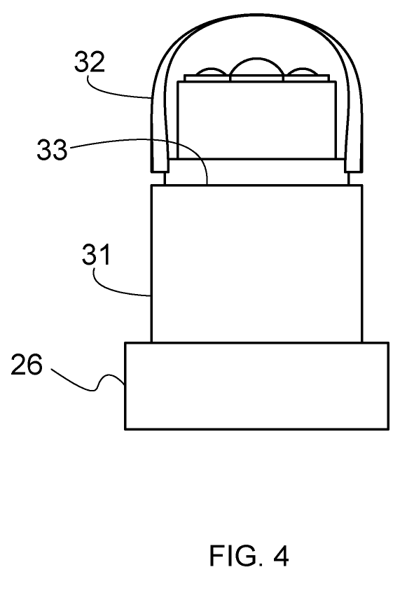

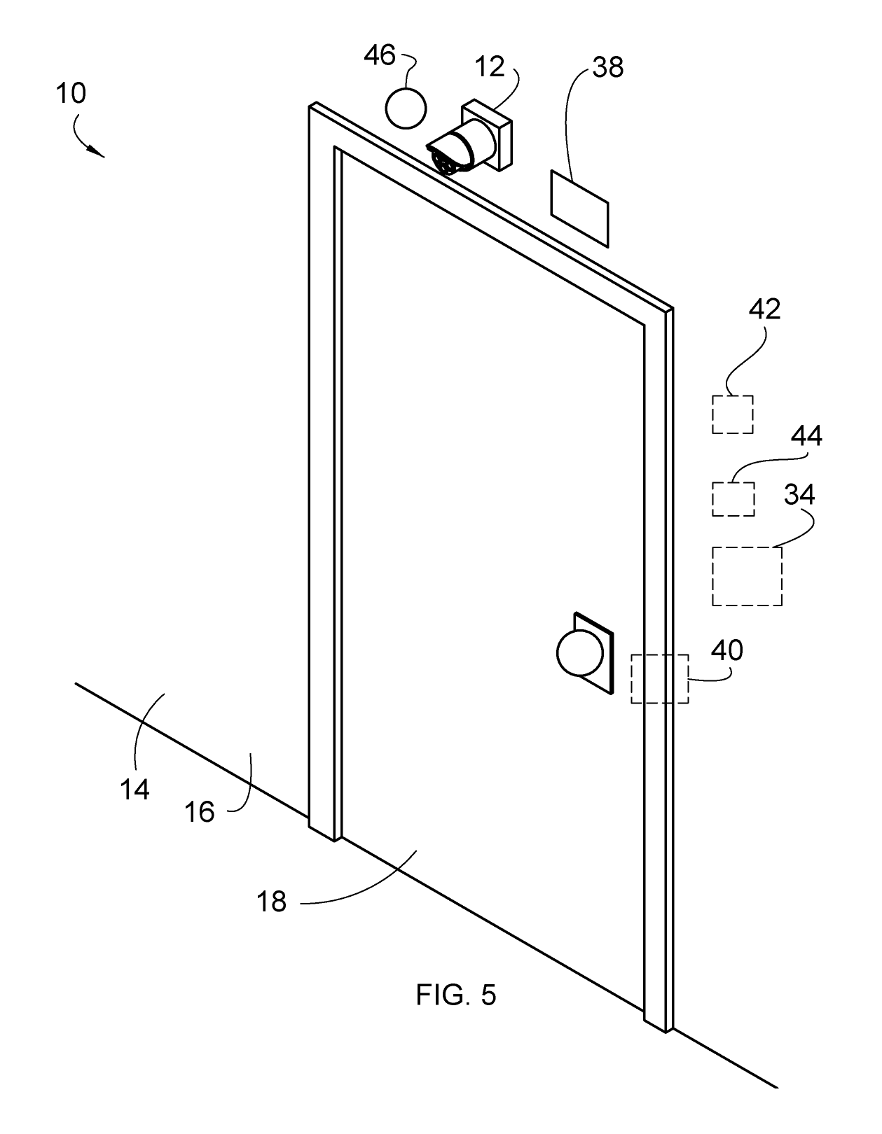

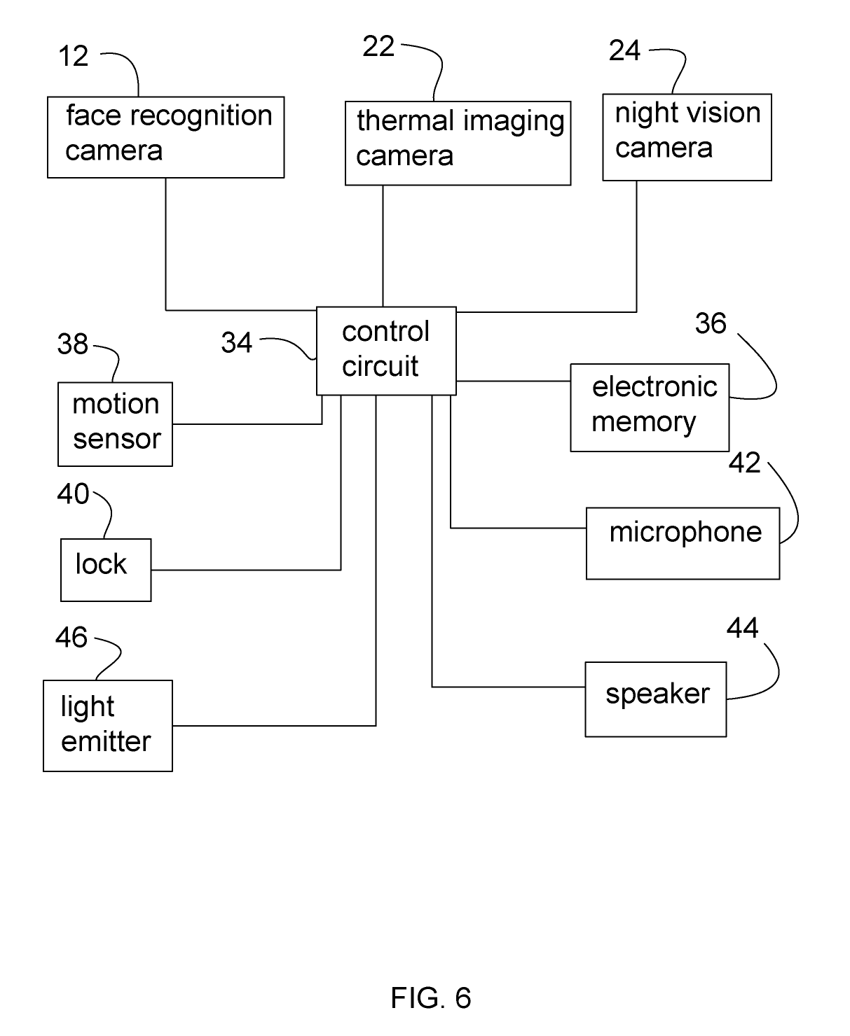

With reference now to the drawings, and in particular to FIGS. 1 through 6 thereof, a new security device embodying the principles and concepts of an embodiment of the disclosure and generally designated by the reference numeral 10 will be described.

As best illustrated in FIGS. 1 through 6, the face recognition security assembly 10 generally comprises a face recognition camera 12 that is mounted on an external wall 14 of a building 16. The building 16 may be a house, a business and any other building 16. The face recognition camera 12 is positioned above a door 18 of the building 16 and the face recognition camera 12 captures images of a face of an individual 20 approaching the door 18. The face recognition camera 12 may be a digital camera with a minimum resolution of 7.0 megapixels and at least a 10× optical zoom.

A thermal imaging camera 22 is provided and the thermal imaging camera 22 is mounted to the external wall 14 of the building 16. The thermal imaging camera 22 is positioned above the door 18 of the building 16 to capture a heat signature of the individual 20 approaching the door 18. The thermal imaging camera 22 may be a digital, infra-red camera or the like. A night vision camera 24 is provided and the night vision camera 24 is mounted to the external wall 14 of the building 16. The night vision camera 24 is positioned above the door 18 of the building 16 to capture images of the individual 20 approaching the door 18 at night. Additionally, the night vision camera 24 may be a digital night vision camera of any conventional design. Each of the face recognition camera 12, the thermal imaging camera 22 and the night vision camera 24 may employ a fish-eye lens to facilitate a 180.0 degree field of view.

A housing 26 is provided that has a back wall 28 and a front wall 30. The back wall 28 of the housing 26 is mounted on the external wall 14 of the building 16 and the housing 26 may be positioned above the door 18. Each of the face recognition camera 12, the thermal imaging camera 22 and the night vision camera 24 are coupled to the front wall 30 of the housing 26. A hood 32 may be coupled to the front wall 30 of the housing 26 and the hood 32 may be positioned above each of the face recognition camera 12, the thermal imaging camera 22 and the night vision camera 24. The hood 32 may shield each of the face recognition camera 12, the thermal imaging camera 22, and the night vision camera 24 from sunlight. A tube 31 may protrude from the front wall 30 of the housing 26 and each of the face recognition camera 12, the thermal imaging camera 22 and the night vision camera 24 may be couple to a distal end 33 of the tube 31. The housing 26 is comprised of a fluid impermeable and rigid material to protect each of the face recognition camera 12, the thermal imaging camera 22 and the night vision camera 24 from damage and the elements.

A control circuit 34 is provided and the control circuit 34 is positioned within the housing 26. The control circuit 34 is electrically coupled to each of the face recognition camera 12, the thermal imaging camera 22 and the night vision camera 24. Moreover, the control circuit 34 controls operational parameters of the face recognition camera 12, the thermal imaging camera 22 and the night vision camera 24. The control circuit 34 includes conventional electronic circuitry associated with face recognition cameras.

The control circuit 34 includes an electronic memory 36 and the electronic memory 36 stores data comprising control software. The control software controls each of the face recognition camera 12, the thermal imaging camera 22 and the night vision camera 24. Additionally, the electronic memory 36 stores images captured by each of the face recognition camera 12, the night vision camera 24 and the thermal imaging camera 22. The electronic memory 36 may be a hard disk drive, solid state memory and any other means of electronic data storage. The control circuit 34 is electrically coupled to a power source comprising an electrical system in the building 16.

A motion sensor 38 is coupled to the front wall 30 of the housing 26 to sense the individual 20 approaching the door 18. The motion sensor 38 is electrically coupled to the control circuit 34. Each of the face recognition camera 12, the thermal imaging camera 22 and the night vision camera 24 is turned on when the motion sensor 38 senses the individual 20 approaching the door 18. Additionally, the motion sensor 38 may be an electronic motion sensor 38 of any conventional design.

A lock 40 is coupled to the door 18 such that the lock 40 selectively locks the door 18 when the lock 40 is turned on and the lock 40 is electrically coupled to the control circuit 34. The control circuit 34 turns the lock 40 on when the face recognition camera 12 fails to capture an image of the individual 20's face approaching the door 18. In this way the individual 20 is inhibited from entering the building 16 when the individual 20 attempts to conceal their face. Additionally, the lock 40 may be an electronic lock 40 of any conventional design.

A microphone 42 is positioned within the building 16 to detect verbal commands and the microphone 42 is electrically coupled to the control circuit 34. Thus, the control circuit 34 responds to a variety of spoken commands for controlling operational parameters of the face recognition camera 12, the thermal imaging camera 22, the night vision camera 24 and the lock 40. A speaker 44 is positioned within the building 16 and the speaker 44 emits audible sounds. The speaker 44 is electrically coupled to the control circuit 34 and the speaker 44 emits audible warnings, such as an alert the face recognition camera 12 has failed to capture an image of the individual's 20 face, that the lock 40 has been turned on and various other operational parameters.

A light emitter 46 is coupled to the external wall 14 of the building 16 and the light emitter 46 emits light that is not visible to the human eye. The light emitter 46 enhances the imaging capability of the night vision camera 24 to increase detail that is rendered by the night vision camera 24. The light emitter 46 is electrically coupled to the control circuit 34.

In use, the control circuit 34 turns on the face recognition camera 12, the thermal imaging camera 22 and the night vision camera 24 when the motion sensor 38 senses the individual 20 approaching the door 18 of the building 16. The control circuit 34 turns the lock 40 on when the face recognition camera 12 fails to capture an image of the individual's 20 face. In this way the individual 20 is inhibited from entering the building 16 when the individual 20 attempts to conceal their face. Additionally, the speaker 44 announces that the door 18 has been locked thereby alerting occupants of the building 16 of a potential threat of forced entry into the building 16. The images captured by the thermal imaging camera 22, the night vision camera 24 and the face recognition camera 12 are selectively downloaded from the electronic memory 36 and are provided to law enforcement for investigation when the individual 20 attempts to forcibly enter the building 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A face recognition security assembly being configured to be mounted on a building thereby facilitating selective door into the building, said assembly comprising:
a face recognition camera being configured to be mounted on an external wall of a building, said face recognition camera being positioned above an door of the building wherein said face recognition camera is configured to capture images of a face of an individual approaching the door; and
a lock being configured to be coupled to the door such that said lock selectively locks the door when said lock is turned on, said lock being turned on when said face recognition camera fails to capture an image of the individual's face approaching the door.

2. The assembly according to claim 1, further comprising a thermal imaging camera being configured to be mounted to the external wall of the building, said thermal imaging camera being positioned above the door of the building wherein said thermal imaging camera is configured to capture a heat signature of the individual approaching the door.

3. The assembly according to claim 2, further comprising night vision camera being configured to be mounted to the external wall of the building, said night vision camera being positioned above the door of the building wherein said night vision camera is configured to capture images of the individual approaching the door at night.

4. The assembly according to claim 3, further comprising a housing having a back wall and a front wall, said back wall of said housing being configured to be mounted on the external wall of the building, each of said face recognition camera, said thermal imaging camera and said night vision camera being coupled to said front wall of said housing.

5. The assembly according to claim 4, further comprising a control circuit being positioned within said housing, said control circuit being electrically coupled to each of said face recognition camera, said thermal imaging camera and said night vision camera, said control circuit controlling operational parameters of said face recognition camera, said thermal imaging camera and said night vision camera.

6. The assembly according to claim 5, wherein said control circuit includes an electronic memory, said electronic memory storing data comprising control software for each of said face recognition camera, said thermal imaging camera and said night vision camera, said electronic memory storing images captured by each of said face recognition camera, said night vision camera and said thermal imaging camera, said control circuit being electrically coupled to a power source comprising an electrical system in the building.

7. The assembly according to claim 5, further comprising a motion sensor being coupled to said front wall of said housing wherein said motion sensor is configured to sense the individual approaching the door, said motion sensor being electrically coupled to said control circuit, each of said face recognition camera, said thermal imaging camera and said night vision camera being turned on when said motion sensor senses the individual approaching the door.

8. The assembly according to claim 5, wherein said lock is electrically coupled to said control circuit, said control circuit turning said lock on when said face recognition camera fails to capture the individual's face.

9. A face recognition security assembly being configured to be mounted on a building thereby facilitating selective door into the building, said assembly comprising:
a face recognition camera being configured to be mounted on an external wall of a building, said face recognition camera being positioned above an door of the building wherein said face recognition camera is configured to capture images of a face of an individual approaching the door;
a thermal imaging camera being configured to be mounted to the external wall of the building, said thermal imaging camera being positioned above the door of the building wherein said thermal imaging camera is configured to capture a heat signature of the individual approaching the door;
a night vision camera being configured to be mounted to the external wall of the building, said night vision camera being positioned above the door of the building wherein said night vision camera is configured to capture images of the individual approaching the door at night;
a housing having a back wall and a front wall, said back wall of said housing being configured to be mounted on the external wall of the building, each of said face recognition camera, said thermal imaging camera and said night vision camera being coupled to said front wall of said housing;
a control circuit being positioned within said housing, said control circuit being electrically coupled to each of said face recognition camera, said thermal imaging camera and said night vision camera, said control circuit controlling operational parameters of said face recognition camera, said thermal imaging camera and said night vision camera, said control circuit including an electronic memory, said electronic memory storing data comprising control software for each of said face recognition camera, said thermal imaging camera and said night vision camera, said electronic memory storing images captured by each of said face recognition camera, said night vision camera and said thermal imaging camera, said control circuit being electrically coupled to a power source comprising an electrical system in the building;
a motion sensor being coupled to said front wall of said housing wherein said motion sensor is configured to sense the individual approaching the door, said motion sensor being electrically coupled to said control circuit, each of said face recognition camera, said thermal imaging camera and said night vision camera being turned on when said motion sensor senses the individual approaching the door; and
a lock being configured to be coupled to the door such that said lock selectively locks the door when said lock is turned on, said lock being electrically coupled to said control circuit, said control circuit turning said lock on when said face recognition camera fails to capture an image of the individual's face approaching the door.
